(19) United States
(12) Patent Application Publication
(10) Pub. No.: US 2018/0134200 A1
(43) Pub. Date: May 17, 2018

(54) CLIMATE CONTROLLED CONTAINER FOR VEHICLE

(71) Applicant: Wal-Mart Stores, Inc., Bentonville, AR (US)

(72) Inventors: Bruce W. Wilkinson, Rogers, AR (US); Todd D. Mattingly, Bentonville, AR (US); Brian G. McHale, Chadderton Oldham (UK)

(21) Appl. No.: 15/815,102

(22) Filed: Nov. 16, 2017

Related U.S. Application Data
(60) Provisional application No. 62/422,776, filed on Nov. 16, 2016.

(51) Int. Cl. B60N 3/10

(52) U.S. Cl. CPC B60N 3/104

(57) ABSTRACT

In some embodiments, apparatuses, and methods are provided herein useful to maintaining a condition of a removable container. In some embodiments, a system for receiving one or more products comprises a personal vehicle, the personal vehicle including a power source and a removable container, the removable container configured to house the one or more products, the removable container comprising a condition control device, wherein the condition control device is coupled to the power source, and a control circuit, the control circuit configured to receive, from a remote device, an indication of a condition for the removable container and cause the condition control device to maintain the removable container with respect to the condition.

### CROSS-REFERENCE TO RELATED APPLICATION

This application claims the benefit of U.S. Provisional Application No. 62/422,776, filed Nov. 16, 2016, which is incorporated by reference in its entirety herein.

### TECHNICAL FIELD

This invention relates generally to storage devices and, more particularly, to powered storage devices.

### BACKGROUND

Many people shop for, and purchase, goods without going to a retail shopping facility (e.g., online or over the phone). After making a purchase, the purchased items are typically delivered to a person's home via a traditional delivery service. Unless the person is home when the items are delivered, the items will remain outside of the person's home, for example on a front porch, until the person returns home. Dependent upon the outdoor temperature, it can be difficult to deliver perishable products. Additionally, because traditional delivery services often leave items at peoples' homes in unsecure locations, there is a risk of theft. Consequently, there is a need for a better delivery mechanisms.

### BRIEF DESCRIPTION OF THE DRAWINGS

Disclosed herein are embodiments of systems, apparatuses, and methods pertaining to a system for receiving products that can maintain a desired condition of a removable container. This description includes drawings, wherein:

FIG. 1 depicts a container 106 including a condition control device 108, according to some embodiments;

FIG. 2 is a block diagram depicting a system 200 including a container 202 with a condition control device 206, according to some embodiments; and

FIG. 3 is a flow chart depicting for maintaining a condition within a container, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to maintaining a condition of a removable container. In some embodiments, a system for receiving one or more products comprises a personal vehicle, the personal vehicle including a power source and a removable container, the removable container configured to house the one or more products, the removable container comprising a condition control device, wherein the condition control device is coupled to the power source, and a control circuit, the control circuit configured to receive, from a remote device, an indication of a condition for the removable container and cause the condition control device to maintain the removable container with respect to the condition.

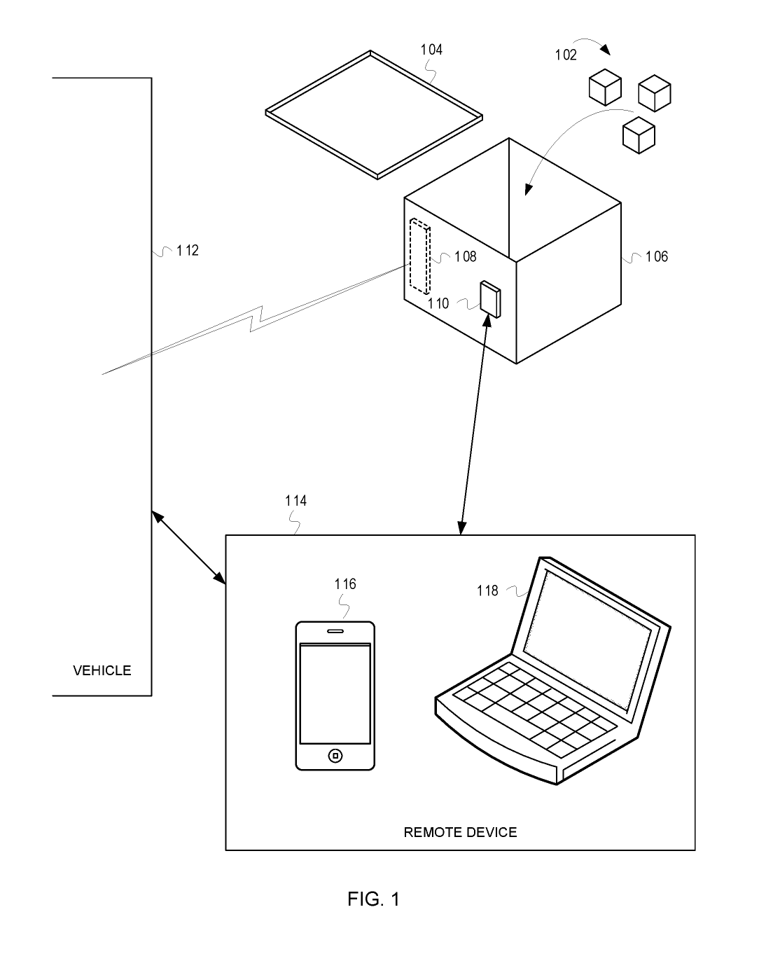

As previously discussed, traditional delivery services have several drawbacks. Specifically, with regard to this discussion, traditional delivery services make delivery of perishable items difficult and can allow for easy theft of packages that have been delivered. Systems, methods, and apparatuses are described herein that can eliminate, or at least reduce, some of these drawbacks. Some embodiments include a container that is integrated into a vehicle. The container can have the ability to maintain a condition (e.g., temperature, humidity, etc.) in an effort to allow delivery and storage of perishable items. Additionally, because the container is within a vehicle, the container allows for secure storage of items delivered. The discussion of FIG. 1 provides a general overview of such a container.

FIG. 1 depicts a container 106 including a condition control device 108, according to some embodiments. The container 106 also includes a control circuit 110 and a lid 104. Although FIG. 1 depicts the lid 104 as being separable from the container 106, this is not required. The container 106 is configured to hold products, such as the representative items 102 depicted in FIG. 1. A delivery service can deliver the items 102 to the container 106. For example, a delivery agent can deliver the items 102 to the container 106.

The container 106 is housed within a vehicle 112. The vehicle 112 can be any suitable type of vehicle, such as a commercial vehicle or a personal vehicle. The container 106 can be a removable container (i.e., a container that is designed to be, or can be, easily removed from the vehicle 112) or a non-removable container (i.e., a container that is not designed to be easily removed from the vehicle 112). The vehicle 112 provides power to the container 106. For example, the vehicle 112 can provide power to the container via a standard 12V electrical system or, in the case of vehicles that include a power mechanism in addition to or in lieu of an internal combustion engine, a higher output electrical system. The vehicle 112 can power both the condition control device 108 and the control circuit 110. The condition control device 108 maintains the container 106 with respect to a condition. For example, the condition control device 108 can maintain a temperature, humidity, light condition, or any other suitable condition, within the container 106. Because the container 106 is housed in the vehicle 112 and includes the condition control device 108, products can be delivered to the container 106 for secure, condition-controlled storage.

In some embodiments, a remote device 114 (e.g., a mobile device 116 or a computing device 118) can communicate with the vehicle 112 and/or the container 106. The remote device 114 can be any device suitable to communicate with the vehicle 112 and/or the container 106. The remote device 114 can communicate with the vehicle 112 and/or the container 106 regarding delivery information. For example, the remote device 114 can communicate an expected delivery time or day, an indication of a delivery agent, an indication of a condition, a command to open or unlock the vehicle 112 and/or the container 106, etc. The remote device 114 can communicate with the vehicle 112 and/or the container 106 via a short range communications medium (e.g., a near field communication (NFC) network) and/or a long range communications medium (e.g., a wide area wireless network such as a WWAN or PSTN). In the case of a remote device 114 that communicates via a short range communications medium, a delivery agent can carry the remote device 114 and use the remote device 114 to transmit delivery information to the vehicle 112 and/or the container 106. In the case of a remote device 114 that communicates via a long range communications medium, the remote device 114 can be a server (e.g., a backend server) that transmits delivery information to the vehicle 112 and/or the container 106. Additionally, in some embodiments, multiple remote devices 114 can be used. For example, a delivery agent can carry a mobile device 116 to transmit delivery information to the vehicle 112 and/or the container 106 and computing device 118 can also transmit delivery information to the vehicle 112 and/or the container 106.

In some embodiments, the container 106 can pair with the vehicle 112. For example, the container 106 can pair with an infotainment system of the vehicle 112. The container 106 can pair with the vehicle's 112 infotainment system in a wireless or wired manner. In some embodiments, the container 106 pairs with the vehicle's 112 infotainment system in a handshake manner including authentication, or can simply pair with the vehicle's 112 infotainment system when placed in the vehicle 112. In such embodiments, the remote device 114 can communicate with the vehicle 112 and the vehicle's 112 infotainment system can transmit commands to the container 106. Such a configuration can allow the container 106 to be used with multiple difference vehicles 112.

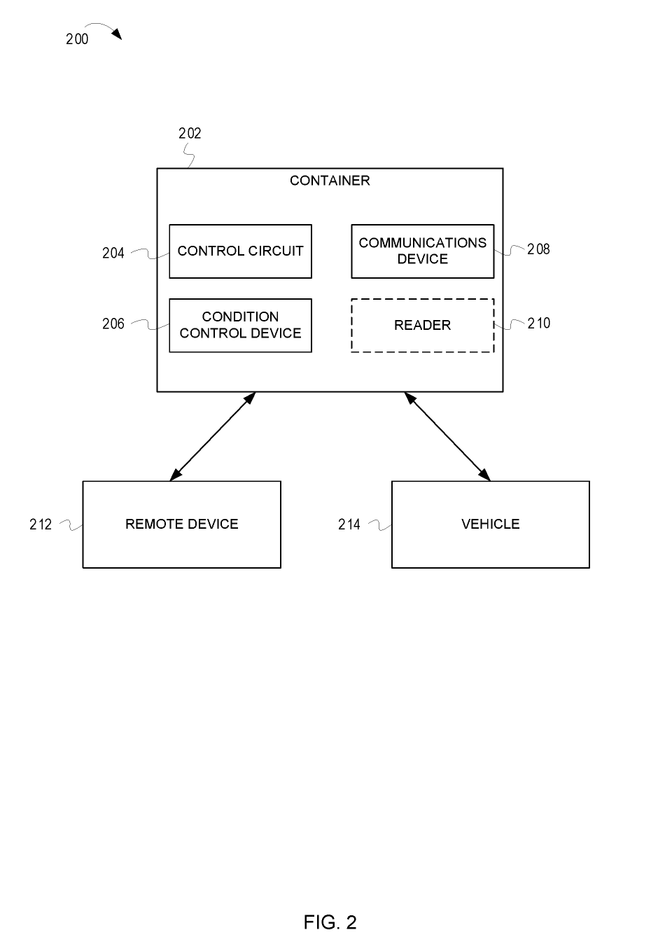

While the discussion of FIG. 1 provides a general overview of a container that includes a condition control device, the discussion of FIG. 2 provides additional details regarding a system including such a container.

FIG. 2 is a block diagram depicting a system 200 including a container 202 with a condition control device 206, according to some embodiments. The container 202 also includes a control circuit 204 and a communications device 208. In some embodiments, the container 202 can also include a reader 210 (discussed in more detail below). The control circuit 204 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 204 is configured (for example, by using corresponding programming as will be well understood by those skilled in the art) to carry out one or more of the steps, actions, and/or functions described herein.

By one optional approach the control circuit 204 operably couples to a memory. The memory may be integral to the control circuit 204 or can be physically discrete (in whole or in part) from the control circuit 204 as desired. This memory can serve, for example, to non-transitorily store the computer instructions that, when executed by the control circuit 204, cause the control circuit 204 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The container 202 receives, and in some embodiments transmits, information from a remote device 212 and a vehicle 214 via the communications device 208. The remote device 212 transmits delivery information to the container 202 and/or the vehicle 214. In embodiments in which the container 202 pairs with the vehicle 214, the communications device 208 can pair with, for example, the vehicle's 214 infotainment system. The vehicle 214 provides power to the container 202 (e.g., to the control circuit 204, the condition control device 206, the communications device 208, and/or the reader 210).

As a single example of the system 200, the container 202 can be a removable container that is housed within a cargo area of the vehicle 214. A customer can place an order, for example online or over the phone, for one or more items and request that the items be delivered to the container 202. In some embodiments, the customer can provide a location of the vehicle 214 (and consequently the container 202) at the time of the order. In other embodiments, the system 200 (e.g., the remote device 212) can determine a location of the vehicle 214 at or near the time of delivery of the items. In such embodiments, the system 200 (e.g., the remote device 212) can plan a delivery route for the delivery agent based on the location of the vehicle 214 as well as any other delivery locations. If the one or more items include items that require specific conditions (e.g., temperature, humidity, light conditions, etc.), the remote device 212 can transmit delivery information, including an indication of the conditions, to the container 202. In some embodiments, the delivery information can include a delivery time and the control circuit 204 can cause the condition control device 206 to prepare the container 202 (e.g., by cooling the container 202) so that the container 202 has met the condition by the time the items are delivered. When the delivery agent arrives at the vehicle 214, the remote device 212, whether carried by the delivery agent or a server, can transmit a command to the container 202 and/or the vehicle 214 that causes the vehicle 214 to allow the delivery agent access. For example, the remote device 212 can transmit a command to the vehicle 214 that causes the vehicles door to be unlocked or trunk opened. Once the delivery agent has secured access to the vehicle 214 and the container 202, the delivery agent can deliver the items to the container 202.

As briefly alluded to, in some embodiments, the container 202 can include a reader 210. The reader 210 can be an optical reader, NFC reader, etc. The reader 210 can function to identify items that are being placed in the container 202. For example, the reader 210 can read indicators, such as barcodes or RFID tags, off of items as they are placed in the container 202. The indicators can identify a condition associated with an item or identify the item. If the indicator identifies a condition associated with the item, the control circuit 204 can cause the condition control device 206 to maintain the container 202 with respect to the identified condition. If the indicator identifies the item, the control circuit 204 can determine a condition associated with the item. For example, the control circuit 204 can access a database (not shown) to determine a condition associated with an item, or transmit a message to the remote device 212 requesting a condition associated with the item.

If the container 202 does not include a reader 210, the remote device 212 can transmit an indication of the condition to the container. For example, the remote device 212 may be aware of which items are in an order and conditions associated with each of the items. Alternatively, the remote device 212 can include a reader that performs a function similar to the reader 210 described above. In either case, the remote device 212 transmits an indication of conditions associated with any of the items to the container 202 and the control circuit causes the condition control device to maintain the container 202 with respect to the condition.

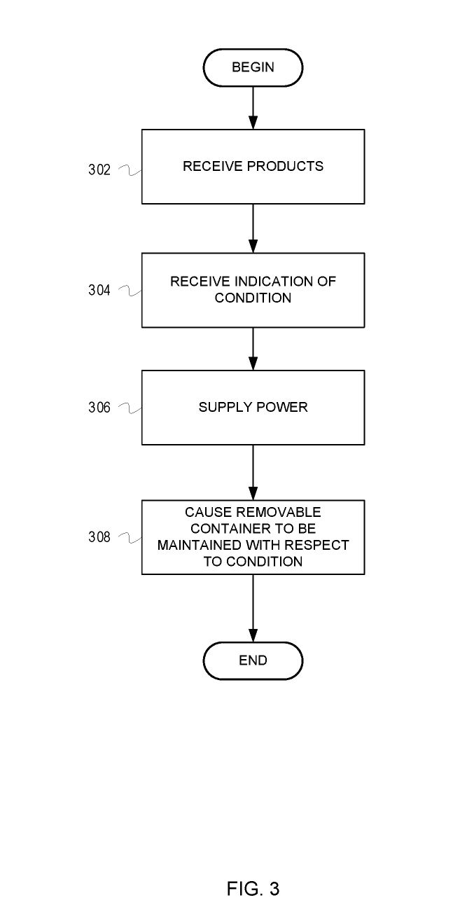

While the description of FIG. 2 provides additional details about a container that includes a condition control device, the description of FIG. 3 describes example operations for receiving products in a container and maintaining the container with respect to the condition.

FIG. 3 is a flow chart depicting for maintaining a condition within a container, according to some embodiments. The flow begins at block 302.

At block 302, products are received. For example, the products (or items) can be received by a container. The container can be housed within a vehicle. The container, or at least a portion of the container, can be removable from the vehicle or non-removable. The flow continues at block 304.

At block 304, an indication of a condition is received. For example, the container can receive an indication of the condition. The condition can be a temperature, humidity, light condition, movement condition, or any other suitable condition. As one example, the condition can be a temperature at which perishable foods should be stored. The container can receive the condition from a reader integrated with the container or from a remote device. For example, the remote device can transmit an indication of the condition to the container, or the remote device can transmit identify an item and the container can receive the indication of the condition by determining the condition based on the identification of the item received from the remote device. The flow continues at block 306.

At block 306, power is supplied. For example, the vehicle can supply power to the container. The vehicle can supply power from a standard electrical system (i.e., the container is designed to connect to a vehicle's existing electrical system) or an electrical system designed specifically for the container. The vehicle supplies power to the container to run the control circuit and the condition control device, as well as any other electronic devices that are associated with the container (e.g., a reader, communications device, etc.). In some embodiments, the container, or the vehicle, can estimate the amount of energy required to maintain the container with respect to the condition and determine whether the electrical system is capable, in its current state, or maintaining the container with respect to the condition until the customer arrives. If the electrical system is not capable, or there is an unexpected loss of power, the vehicle can run an additional power source (e.g., an internal combustion engine or other electrical system) to power the container. For example, if the vehicles 12V battery can no longer power the container, the vehicle can run its internal combustion engine to charge the 12V battery (i.e., replenish the battery) and power the container. Once the vehicle's 12V battery is charged sufficiently, the internal combustion engine can shut off. The flow continues at block 308.

At block 308, the container is maintained with respect to the condition. For example, a control circuit can cause the condition control device to maintain the container with respect to the condition. As one example, if the item is a warm meal and the condition is a temperature of 135 degrees Fahrenheit, the control circuit can cause the condition control device to maintain the container at, or near, 135 degrees Fahrenheit. In some embodiments, the container can include multiple sections, each section capable of being maintained with respect to a different condition. For example, one section can be maintained at or near 135 degrees Fahrenheit, while a second section can be maintained at or near 37 degrees Fahrenheit. The sections can be designed to accommodate a specific condition, or can be maintained at any number of conditions.

In some embodiments, a system for receiving one or more products comprises a personal vehicle, the personal vehicle including a power source and a removable container, the removable container configured to house the one or more products, the removable container comprising a condition control device, wherein the condition control device is coupled to the power source, and a control circuit, the control circuit configured to receive, from a remote device, an indication of a condition for the removable container and cause the condition control device to maintain the removable container with respect to the condition.

In some embodiments, a method comprises receiving, at a removable container in a personal vehicle, one or more products, receiving, at a control circuit from a remote device, an indication of a condition for the removable container, applying, by a power source to a condition control device associated with the removable container, power, and causing, by the control circuit, the condition control device to maintain the removable container with respect to the condition.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for receiving one or more products sold by a retailer and delivered by delivery agents, the system comprising:
a personal vehicle, the personal vehicle including a power source and a removable container;
the removable container configured to house the one or more products delivered by the delivery agent, the removable container comprising:
a condition control device, wherein the condition control device is coupled to the power source;
a communications device, wherein the communications device is configured to receive, before delivery of the one or more products, delivery information from a remote device, wherein the delivery information includes an indication of a condition for the removable container; and
a control circuit, the control circuit configured to:
determine, based on the delivery information, the condition; and
cause the condition control device to maintain the removable container with respect to the condition prior to delivery of the one or more products by the retailer; and
the remote device, wherein the remote device is carried by the delivery agent, and wherein the remote device is configured to:
transmit, prior to delivery, the delivery information to the removable container.

2. The system of claim 1, wherein the removable container includes two or more sections, and the condition for the removable container includes a first condition for a first of the two or more sections and a second condition for a second of the two or more sections.

3. The system of claim 1, wherein the condition is one or more of temperature and humidity.

4. The system of claim 1, wherein the control circuit is further configured to:
determine an identity of at least one of the one or more products; and
transmit, to the remote device, the identity of the at least one of the one or more products.

5. The system of claim 1, wherein the remote device receives de delivery information from a backend server prior to transmitting the delivery information to the removable container.

6. The system of claim 1, wherein the personal vehicle is configured to maintain the power supply while the control circuit causes the control device to maintain the removable container with respect to the condition.

7. The system of claim 1, wherein the control circuit is further configured to notify a customer upon receipt of the one or more products.

8. The system of claim 1, wherein the remote device is a mobile device.

9. The system of claim 1, wherein the control circuit is configured to cause the condition control device to maintain the removable container with respect to the condition before the one or more products are received.

10. The system of claim 1, wherein the removable container pairs with the vehicle.

11. A method for receiving one or more products sold by a retailer and delivered by delivery agents, the method comprising:
transmitting, by a remote device prior to delivery of the one or more products by the retailer, delivery information to a removable container, wherein the delivery information includes an indication of a condition, and wherein the removable container is in a personal vehicle, and wherein the remote device is carried by a delivery agent;
receiving, at the removable container, the one or more products;
determining, by a control circuit based on the delivery information, the condition for the removable container;
supplying, by a power source to a condition control device associated with the removable container, power; and
causing, by the control circuit, the condition control device to maintain the removable container with respect to the condition prior to delivery of the one or more items by the retailer.

12. The method of claim 11, wherein the removable container includes two or more sections, and wherein the condition for the removable container includes a first condition for a first of the two or more section and a second condition for a second of the two or more conditions.

13. The method of claim 12, wherein the condition is one or more temperature and humidity.

14. The method of claim 11, further comprising:
determining, by the control circuit, an identity of at least one of the one or more products; and
transmitting, by the control circuit, the identity of the least one of the one or more products.

15. The method of claim 14, wherein the remote device receives the delivery information from a backend server prior to transmitting the delivery information to the removable container.

16. The method of claim 11, further comprising:
determining that the power source needs to be replenished; and
providing, by the personal vehicle power to the power source.

17. The method of claim 11, further comprising:
transmitting, by the control circuit, a notification to a customer upon receipt of the one or more products.

18. The method of claim 11, wherein the causing the condition control device to maintain the removable container with respect to the condition before the receiving the one or more products.

19. The method of claim 11, wherein the removable container pairs with the vehicle.
